(19) United States
(12) Patent Application Publication
(10) Pub. No.: US 2018/0115731 A1
(43) Pub. Date: Apr. 26, 2018

(54) GLOBAL SHUTTER HIGH DYNAMIC RANGE PIXEL AND GLOBAL SHUTTER HIGH DYNAMIC RANGE IMAGE SENSOR

(71) Applicant: PixArt Imaging Incorporation, HsinChu (TW)

(72) Inventors: Yung-Chung Lee, HsinChu (TW); Yi-Cheng Chiu, HsinChu (TW); Hsin-Hui Hsu, HsinChu (TW); Jui-Te Chiu, HsinChu (TW); Han-Chi Liu, HsinChu (TW)

(21) Appl. No.: 15/598,886

(22) Filed: May 18, 2017

(30) Foreign Application Priority Data
Oct. 20, 2016 (TW) 105133822

(51) Int. Cl. H04N 5/3745; H04N 5/378; H04N 5/355

(52) U.S. Cl. CPC H04N 5/37452; H04N 5/3559; H04N 5/378

(57) ABSTRACT

The present invention provides a global shutter high dynamic range pixel and a global shutter high dynamic range image sensor. The global shutter high dynamic range pixel includes: a photoelectric transducer unit, a floating node, a first charge transfer unit, a second charge transfer unit and a pixel signal output unit. The first charge transfer unit includes a Metal-Oxide-Semiconductor (MOS) capacitor. The MOS capacitor is configured to operably accumulate at least a portion of the charges transferred from the photoelectric transducer unit. The MOS capacitor is turned ON or OFF according to a control signal, thereby forming a gate-induced potential well internally within the MOS capacitor, so as to control the portion of charges.

### CROSS REFERENCE

The present invention claims priority to TW105133822, filed on Oct. 20, 2016.

### BACKGROUND OF THE INVENTION

### Field of Invention

The present invention relates to a global shutter high dynamic range pixel and a global shutter high dynamic range image sensor; particularly, it relates to such global shutter high dynamic range pixel and global shutter high dynamic range image sensor which are capable of controlling the transfer of the charges through a gate-induced potential well which is formed internally within a metal-oxide-semiconductor (MOS) capacitor of the global shutter high dynamic range pixel.

### Description of Related Art

A conventional image sensor generally has plural sensing pixels arranged in array. The exposure of the sensing pixels is controlled by a shutter. The image sensor employs one of two typical shutter modes: rolling shutter and global shutter. In the rolling shutter mode, the sensing pixels are exposed and read-out row-by-row. Since each row of the sensing pixels is successively activated instead of simultaneously activated (i.e. different rows of the sensing pixels start exposure are different timings), when an object to be captured is fast moving, the image captured may be distorted.

In contrast, when operating in the global shutter mode, all the sensing pixels are exposed simultaneously (i.e. all rows of the sensing pixels start exposure are the same timing), and each row is read out individually. The global shutter can avoid the distortion problem.

For relevant details of an image sensor using global shutter, please refer to U.S. Pat. No. 7,361,877.

In view of the above, the present invention proposes a global shutter high dynamic range pixel and a global shutter high dynamic range image sensor which are capable of controlling the transfer of the charges through a gate-induced potential well which is formed internally within a MOS capacitor of the global shutter high dynamic range pixel.

### SUMMARY OF THE INVENTION

From one perspective, the present invention provides a global shutter high dynamic range pixel, comprising: a photoelectric transducer unit, which is configured to operably receive a light signal and generate and accumulate charges accordingly, so as to output a sensing signal corresponding to the charges; a floating node, which is configured to operably accumulate at least a first portion and/or a second portion of the charges transferred from the photoelectric transducer unit as floating charges; a first charge transfer unit, which is coupled between the photoelectric transducer unit and the floating node and which is configured to operably transfer at least the first portion of the charges from the photoelectric transducer unit to the floating node during a first charge transfer period; a second charge transfer unit, which is coupled between the photoelectric transducer unit and the floating node and which is configured to operably transfer at least the second portion of the charges from the photoelectric transducer unit to the floating node during a second charge transfer period, wherein the second charge transfer period is shorter than the first charge transfer period; and a pixel signal output unit, which has one end coupled to the floating node and which is configured to operably generate a first pixel signal corresponding to a first voltage potential in the floating node during the first charge transfer period and/or to operably generate a second pixel signal corresponding to a second voltage potential in the floating node during the second charge transfer period; wherein the first charge transfer unit at least includes: a metal-oxide-semiconductor (MOS) capacitor, which is configured to operably and temporarily accumulate the first portion of the charges transferred from the photoelectric transducer unit, the MOS capacitor being turned ON or OFF according to a first control signal, whereby a gate-induced potential well is formed internally within the MOS capacitor, so as to control the transfer of the first portion of the charges.

From another perspective, the present invention provides a global shutter high dynamic range image sensor, comprising: a global shutter high dynamic range pixel array, including: a plurality of global shutter high dynamic range pixels arranged in a matrix of rows and columns, each of the global shutter high dynamic range pixel includes: a photoelectric transducer unit, which is configured to operably receive a light signal and generate and accumulate charges accordingly, so as to output a sensing signal corresponding to the charges; a floating node, which is configured to operably accumulate at least a first portion and/or a second portion of the charges transferred from the photoelectric transducer unit as floating charges; a first charge transfer unit, which is coupled between the photoelectric transducer unit and the floating node and which is configured to operably transfer at least a first portion of the charges from the photoelectric transducer unit to the floating node during a first charge transfer period; a second charge transfer unit, which is coupled between the photoelectric transducer unit and the floating node and which is configured to operably transfer at least a second portion of the charges from the photoelectric transducer unit to the floating node during a second charge transfer period, wherein the second charge transfer period is shorter than the first charge transfer period; and a pixel signal output unit, which has one end coupled to the floating node and which is configured to operably generate a first pixel signal corresponding to a first voltage potential in the floating node during the first charge transfer period and/or a second pixel signal corresponding to a second voltage potential in the floating node during the second charge transfer period; wherein the first charge transfer unit includes: a MOS capacitor, which is configured to operably and temporarily accumulate at least the first portion of the charges transferred from the photoelectric transducer unit, the MOS capacitor being turned ON or OFF according to a first control signal, whereby a gate-induced potential well is formed internally within the MOS capacitor, so as to control the transfer of the first portion of the charges; a control circuit, which is coupled to the global shutter high dynamic range pixel array and which is configured to operably generate the first control signal, so as to control the plurality of global shutter high dynamic range pixels; a pixel signal readout circuit, which is coupled to the global shutter high dynamic range pixel array and which is configured to operably read out the first pixel signal and the second pixel signal of each global shutter high dynamic range pixel; and an image processing circuit, which is coupled to the pixel signal readout circuit and which is configured to operably process a signal outputted from the pixel signal readout circuit.

In one embodiment, the first charge transfer unit further includes: a shutter switch, which is coupled between the photoelectric transducer unit and one end of the MOS capacitor and which is controlled by a second control signal, so as to control the transfer of the first portion of the charges from the photoelectric transducer unit to the MOS capacitor; and a transfer switch, which is coupled between another end of the MOS capacitor and the floating node, the transfer switch being controlled by a third control signal, so as to control the transfer of the first portion of the charges from the MOS capacitor to the floating node as the floating charges.

In one embodiment, the second charge transfer unit includes: a transfer switch, which is coupled between the photoelectric transducer unit and the floating node, the transfer switch being controlled by a second control signal, so as to control the transfer of at least the second portion of the charges from the photoelectric transducer unit to the floating node as the floating charges.

In one embodiment, the photoelectric transducer unit includes a photodiode, a photo-gate or a photo-conductor.

In one embodiment, the global shutter high dynamic range pixel further includes: a first reset transistor, which is coupled to one end of the photoelectric transducer unit and which is configured to operably reset a level of the photoelectric transducer unit to a first predetermined level; and a second reset transistor, which is coupled to one end of the floating node and which is configured to operably reset a level of the floating node to a second predetermined level.

In one embodiment, the first charge transfer period is from a turned-OFF time point of the first reset transistor to a turned-OFF time point of the shutter switch; and the second charge transfer period is from a turned-OFF time point of the first reset transistor to a turned-OFF time point of the transfer switch.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a block diagram of a global shutter high dynamic range pixel according to an embodiment of the present invention.

FIG. 2 shows a schematic diagram of a global shutter high dynamic range pixel according to a specific embodiment of the present invention.

FIG. 3 shows a block diagram of a global shutter high dynamic range image sensor according to an embodiment of the present invention.

FIG. 4 shows a cross sectional view of a first charge transfer unit PATH1.

FIG. 5 shows a cross sectional view of a second charge transfer unit PATH2.

FIG. 6 shows waveforms of signals of the present invention.

### DESCRIPTION OF THE PREFERRED EMBODIMENTS

The above and other technical details, features and effects of the present invention will be will be better understood with regard to the detailed description of the embodiments below, with reference to the drawings. The drawings as referred to throughout the description of the present invention are for illustration only, to show the interrelations between the circuits and devices, but not drawn according to actual scale.

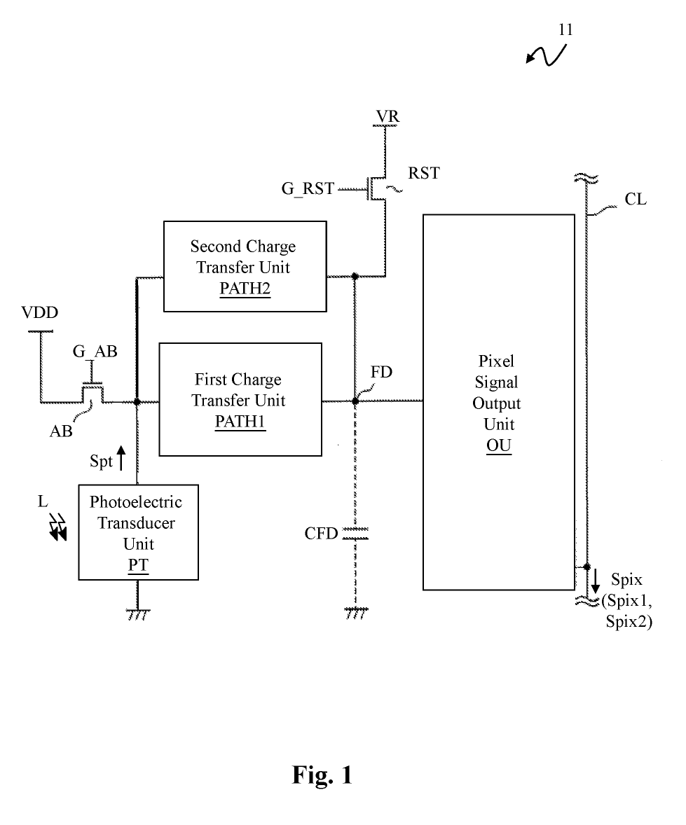

Please refer to FIG. 1, which shows a block diagram of a global shutter high dynamic range pixel according to an embodiment of the present invention.

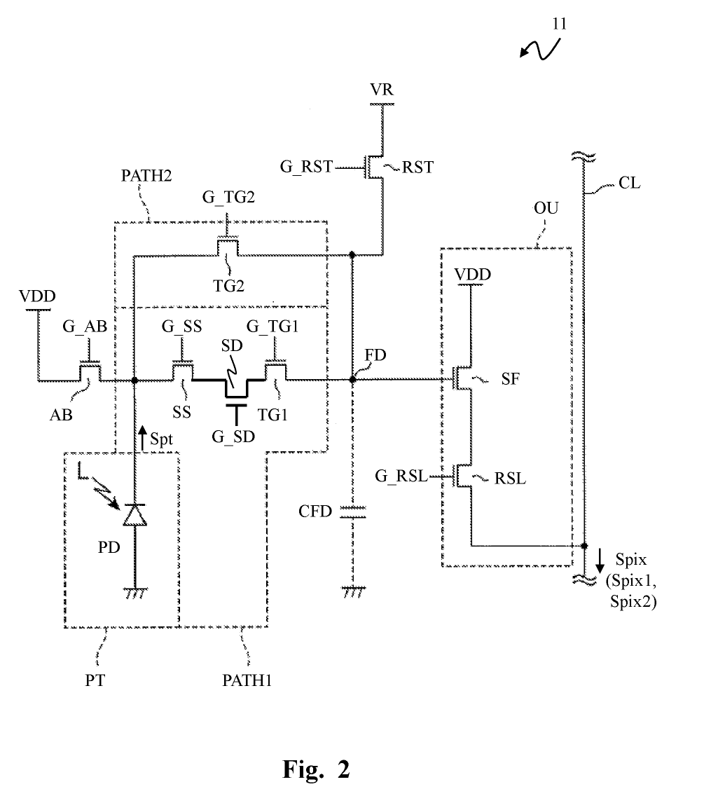

The global shutter high dynamic range pixel 11 of the present invention comprises: a photoelectric transducer unit PT, a floating node FD, a first charge transfer unit PATH1, a second charge transfer unit PATH2 and a pixel signal output unit OU. The photoelectric transducer unit PT is configured to receive a light signal L and generate and accumulate charges accordingly, so as to output a sensing signal Spt corresponding to the charges. In one embodiment, the photoelectric transducer unit PT can include, for example but not limited to, a photodiode PD (as shown in FIG. 2). In other embodiments, the photoelectric transducer unit PT can include, for example but not limited to, a photo-gate or a photo-conductor.

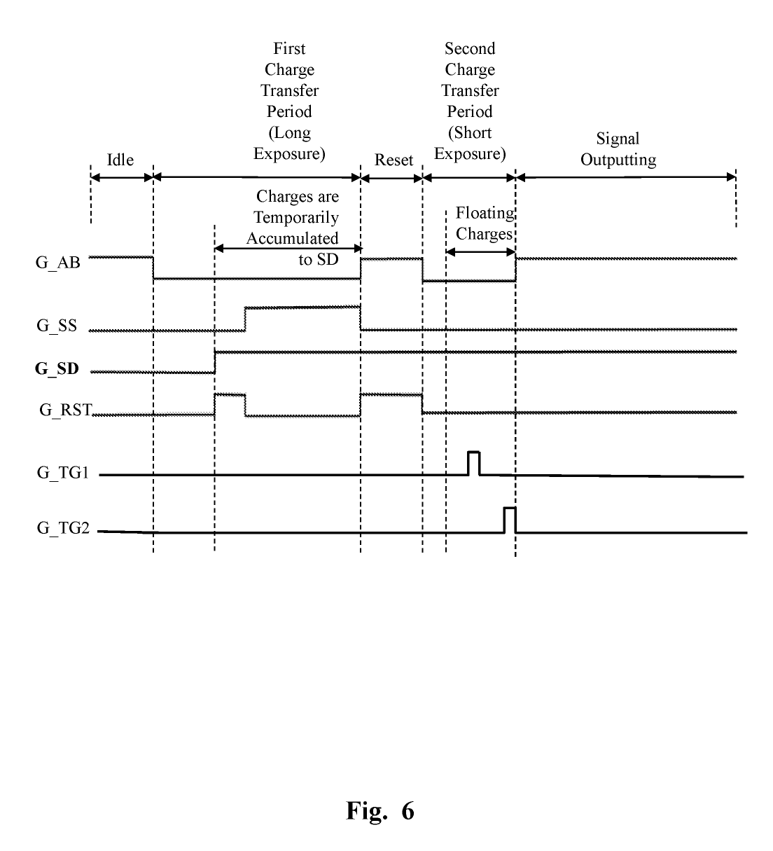

The floating node FD is configured to accumulate at least a portion of the charges transferred from the photoelectric transducer unit PT as floating charges. As shown in FIG. 1, the first charge transfer unit PATH1 is coupled between the photoelectric transducer unit PT and the floating node FD and is configured to transfer at least a portion of the charges from the photoelectric transducer unit PT to the floating node FD during a first charge transfer period. The second charge transfer unit PATH2 is coupled between the photoelectric transducer unit PT and the floating node FD and is configured to operably transfer at least a portion of the charges from the photoelectric transducer unit PT to the floating node FD during a second charge transfer period. In this embodiment, preferably, the second charge transfer period is shorter than the first charge transfer period (please refer to FIG. 6). The pixel signal output unit OU has one end coupled to the floating node FD. The pixel signal output unit OU is configured to generate a first pixel signal Spix1 corresponding to a first voltage potential V in the floating node FD during the first charge transfer period and/or a second pixel signal Spix2 corresponding to a second voltage potential V in the floating node during the second charge transfer period.

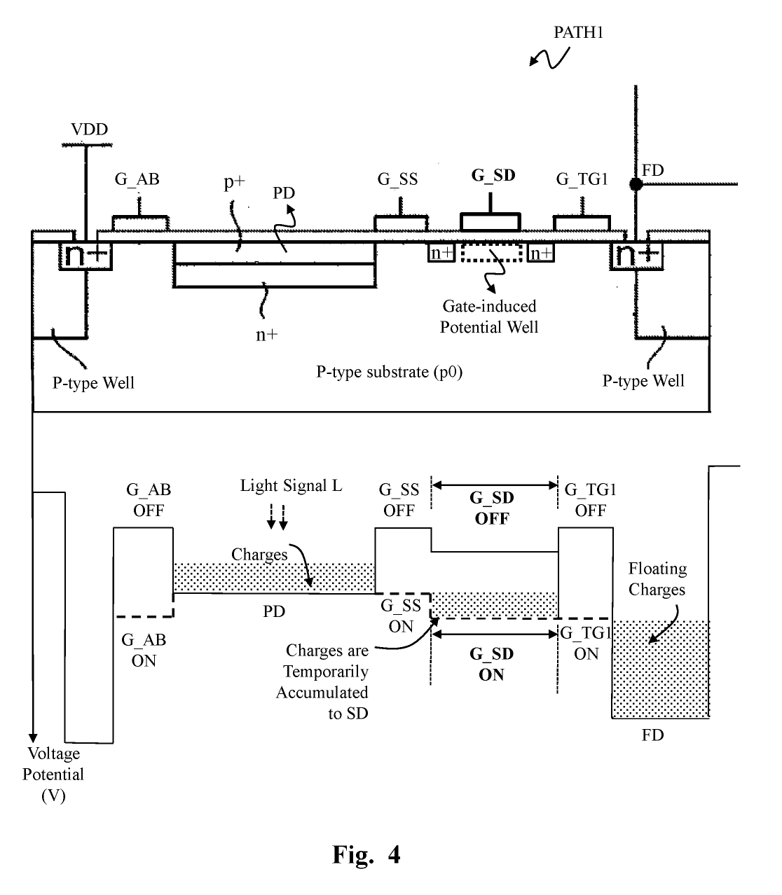

Please refer to FIG. 2 in conjugation with FIG. 4. FIG. 2 shows a schematic diagram of a global shutter high dynamic range pixel according to a specific embodiment of the present invention. FIG. 4 shows a cross sectional view of a first charge transfer unit PATH1. In this embodiment, the global shutter high dynamic range pixel 11 shown in FIG. 4 is formed on, for example but not limited to, a P-type semiconductor substrate. However, the global shutter high dynamic range pixel 11 of the present invention is not limited to being formed on a P-type semiconductor substrate. In other embodiments, the global shutter high dynamic range pixel 11 can be formed on an N-type semiconductor substrate or any other type of semiconductor substrate, with corresponding modifications of the conductivity type and concentration of dopants in the doping regions.

As shown in FIG. 2, in one embodiment, after the photodiode PD receives the light signal L, the photodiode PD generates and accumulates charges, and outputs a sensing signal Spt corresponding to the charges. The thus outputted sensing signal Spt, on one hand, can transfer at least a portion of the charges from the photoelectric transducer unit PT to the floating node FD via the first charge transfer unit PATH1; or, on the other hand, the thus outputted sensing signal Spt can transfer at least a portion of the charges from the photoelectric transducer unit PT to the floating node FD via the second charge transfer unit PATH2.

The photodiode PD of this embodiment for example can have a semiconductor structure as shown by, but not limited to, the cross sectional view of FIG. 4. In brief, there are a P-type region (wherein the P-type dopant concertation thereof is denoted as p+) and an N-type region (wherein the N-type dopant concertation thereof is denoted as n+), which are formed on the P-type semiconductor substrate (wherein the P-type dopant concertation thereof is denoted as p0).

The global shutter high dynamic range pixel 11 of this embodiment can further include a reset transistor AB. As shown in FIG. 2, in one embodiment, the reset transistor AB is coupled to one end of the photoelectric transducer unit PT and is configured to operably reset a level of the photoelectric transducer unit PT to a predetermined level. Such predetermined level can be, for example but not limited to, an internal voltage VDD. The reset transistor AB of this embodiment can be controlled by a reset signal G_AB, which controls whether the reset transistor AB resets the level of the photoelectric transducer unit PT to the predetermined level.

As shown in FIG. 2, in one embodiment, the first charge transfer unit PATH1 can include: a MOS capacitor SD, a shutter switch SS and a transfer switch TG1.

As shown in FIG. 2, the shutter switch SS is coupled between the photoelectric transducer unit PT and one end of the MOS capacitor SD. After the sensing signal Spt corresponding to the charges is generated from the photoelectric transducer unit PT, the ON/OFF of the shutter switch SS and the ON/OFF of the MOS capacitor SD control whether the charges can be transferred from the photoelectric transducer unit PT to the MOS capacitor SD. In this embodiment, the shutter switch SS is controlled by a control signal G_SS, so as to control the transfer of at least a portion of the charges from the photoelectric transducer unit PT to the MOS capacitor SD.

More specifically, when the shutter switch SS is ON and the MOS capacitor SD is ON, at least a portion of the charges are transferred from the photoelectric transducer unit PT to the MOS capacitor SD. The MOS capacitor SD is coupled between the shutter switch SS and the transfer switch TG1. The MOS capacitor SD is configured to operably and temporarily accumulate at least a portion of the charges transferred from the photoelectric transducer unit PT . After at least a portion of the charges have been transferred from the photoelectric transducer unit PT to, and are accumulated in the MOS capacitor SD, the ON/OFF of the MOS capacitor SD and the ON/OFF of the transfer switch TG1 control whether the charges can be transferred from the MOS capacitor SD to the floating node FD via the transfer switch TG1. In this embodiment, the MOS capacitor SD is controlled by a control signal G_SD, and the transfer switch TG1 is controlled by a control signal G_TG1, so as to control the transfer of at least a portion of the charges from the MOS capacitor SD to the floating node FD via the transfer switch TG1.

One main feature of this embodiment is that: there is a gate-induced potential well formed internally within the MOS capacitor SD, which is activated and inactivated as the MOS capacitor SD is turned ON and OFF according to the control signal G_SD. Thus, the MOS capacitor SD can function as a general capacitor for accumulating charges. In addition, this embodiment can control whether at least a portion of the charges can be transferred from the MOS capacitor SD to the floating node FD via the transfer switch TG1 by controlling the MOS capacitor SD according to the control signal G_SD.

The transfer switch TG1 is coupled between another end of the MOS capacitor SD and the floating node FD. As described above, after the charges have been temporarily accumulated in the MOS capacitor SD, the ON/OFF of the transfer switch TG1 and the ON/OFF of the MOS capacitor SD control whether the charges can be transferred from the MOS capacitor SD to the floating node FD, wherein the transfer switch TG1 is controlled by the control signal G_TG1 and the MOS capacitor SD is controlled by the control signal G_SD. The charges transferred to the floating node FD are the so-called floating charges as shown in FIG. 4. In this embodiment, the floating charges in the floating node FD exist in a form of voltage.

The global shutter high dynamic range pixel 11 of this embodiment can further include a reset transistor RST. As shown in FIG. 2, in one embodiment, the reset transistor RST is coupled to one end of the floating node FD and is configured to operably reset a level of the floating node FD to a predetermined level. Such predetermined level can be, for example but not limited to, an internal voltage VR. The reset transistor RST of this embodiment can be controlled by a reset signal G_RST, for controlling whether the reset transistor RST resets the level of the floating node FD to the predetermined level.

In this embodiment, because the first charge transfer unit PATH1 employs the MOS capacitor SD to accumulate charges temporarily, the first charge transfer period which is taken to transfer at least a portion of the charges from the photoelectric transducer unit PT to the floating node FD via the first charge transfer unit PATH1 is longer than the second charge transfer period which is taken to transfer at least a portion of the charges from the photoelectric transducer unit PT to the floating node FD via the second charge transfer unit PATH2.

A specific embodiment of the semiconductor structure of the above-mentioned reset transistor AB, photodiode PD, shutter switch SS, transfer switch TG1 and the floating node FD is shown in the cross sectional view of FIG. 4, as an example. The semiconductor structure of the above-mentioned devices can be embodied in various ways, and the embodiment shown in FIG. 4 is only one of them. In the specific embodiment of the semiconductor structure, a P-type semiconductor substrate is used; however, in other embodiments, an N-type semiconductor substrate or any other type of semiconductor substrate can be used, with corresponding modifications of the conductivity type and concentrations of dopants in the doped regions.

In one embodiment, the pixel signal output unit OU can include, for example but not limited to, a source follower SF and a row selection transistor RSL. The source follower SF is coupled to the floating node FD and is configured to convert the floating charges to signals, i.e., the first pixel signal Spix1 and the second pixel signal Spix2 outputted by the global shutter high dynamic range pixel 11. In this embodiment, the floating charges in the floating node FD exist in a form of voltage. The row selection transistor RSL is coupled to the source follower SF. In one embodiment, the row selection transistor RSL is controlled by a row selection signal G_RSL, so as to enable the row selection transistor RSL to transfer signals.

Because the pixel signal output unit OU is well known to those skilled in the art, the details and other embodiments thereof are not redundantly described here.

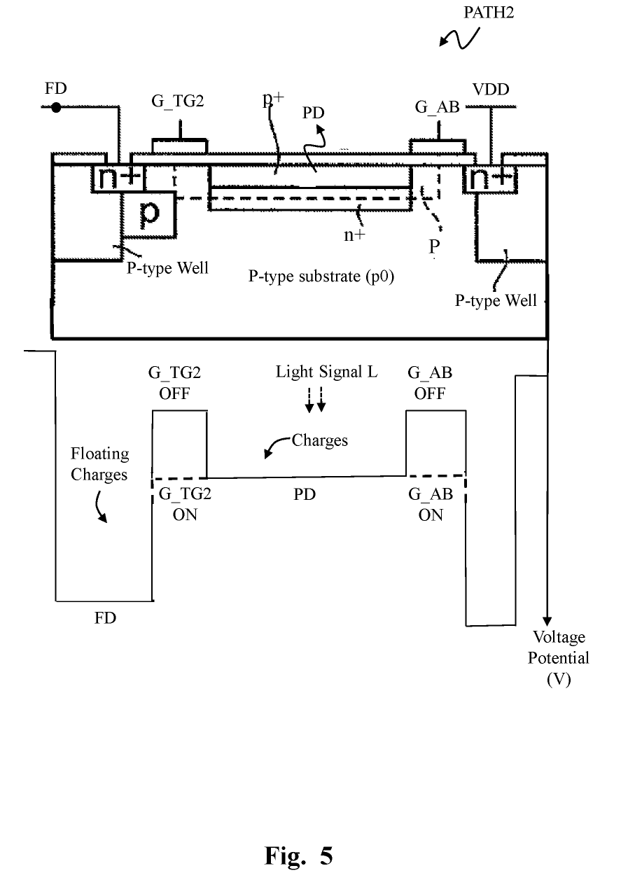

Please refer to FIG. 2 in conjugation with FIG. 5. FIG. 5 shows a cross sectional view of a second charge transfer unit PATH2. In this embodiment, the global shutter high dynamic range pixel 11 is formed on, for example but not limited to, a P-type semiconductor substrate. However, the global shutter high dynamic range pixel 11 of the present invention is not limited to being formed on a P-type semiconductor substrate, but can be formed on an N-type semiconductor substrate or any other type of semiconductor substrate, with corresponding modifications of the conductivity type and concentrations of dopants in the doped regions.

As shown in FIG. 2, in one embodiment, after the photodiode PD receives the light signal L, the photodiode PD generates and accumulates charges, and outputs a sensing signal Spt corresponding to the charges. The thus outputted sensing signal Spt, on one hand, can transfer at least a portion of the charges from the photoelectric transducer unit PT to the floating node FD via the first charge transfer unit PATH1; or, on the other hand, the thus outputted sensing signal Spt can transfer at least a portion of the charges from the photoelectric transducer unit PT to the floating node FD via the second charge transfer unit PATH2.

As shown in FIG. 2, in one embodiment, the second charge transfer unit PATH2 can include a transfer switch TG2. The transfer switch TG2 is coupled between the photoelectric transducer unit PT and the floating node FD. After the sensing signal Spt corresponding to the charges is generated from the photoelectric transducer unit PT, the ON/OFF of the transfer switch TG2 controls whether the charges can be transferred from the photoelectric transducer unit PT to the floating node FD. In this embodiment, the transfer switch TG2 is controlled by a control signal G_TG2, so as to control the transfer of at least a portion of the charges from the photoelectric transducer unit PT to the floating node FD. The charges transferred to the floating node FD are the so-called floating charges, as shown in FIG. 5.

Because the second charge transfer unit PATH2 only employs the transfer switch TG2 to control the transfer of at least a portion of the charges from the photoelectric transducer unit PT to the floating node FD, and because the charges are not stored only in any other device, in the second charge transfer unit PATH2, the second charge transfer period which is taken to transfer at least a portion of the charges from the photoelectric transducer unit PT to the floating node FD via the second charge transfer unit PATH2 is shorter than the first charge transfer period which is taken to transfer at least a portion of the charges from the photoelectric transducer unit PT to the floating node FD via the first charge transfer unit PATH1.

A specific embodiment of the semiconductor structure of the above-mentioned transfer switch TG2 is shown in the cross sectional view of FIG. 5, as an example. The semiconductor structure of the transfer switch TG2 can be embodied in various ways, and the embodiment shown in FIG. 5 is only one of them. In the specific embodiment of the semiconductor structure, a P-type semiconductor substrate is used; however, in other embodiments, an N-type semiconductor substrate or any other type of semiconductor substrate can be used, with corresponding modifications of the conductivity type and concentrations of dopants in the doped region.

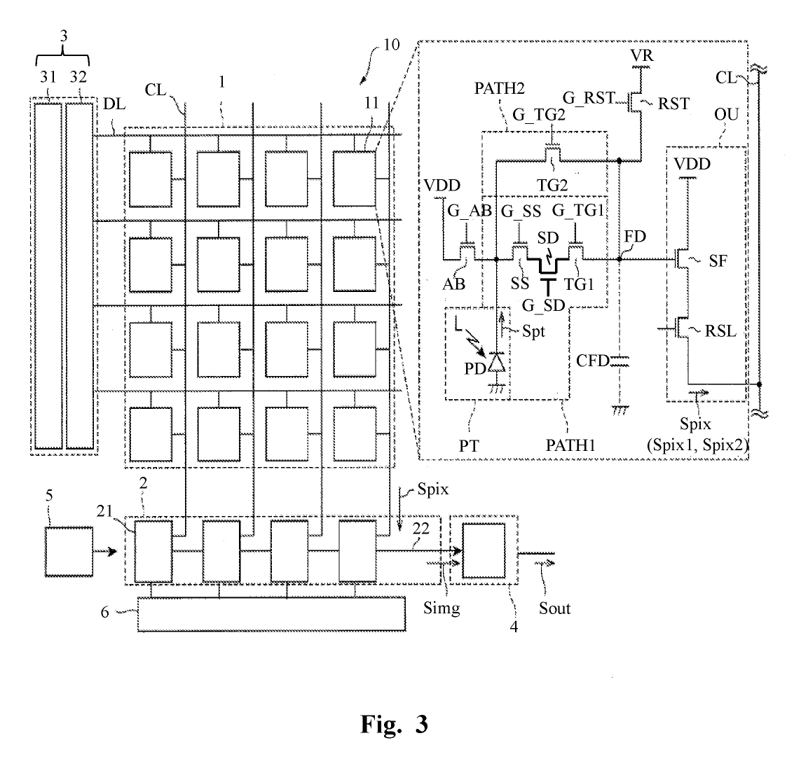

Please refer to FIG. 3, which shows a block diagram of a global shutter high dynamic range image sensor according to an embodiment of the present invention. The global shutter high dynamic range pixel 11 of the present invention can be applied to the global shutter high dynamic range image sensor 10. As shown in the embodiment of FIG. 3, the global shutter high dynamic range image sensor 10 comprise: a global shutter high dynamic range pixel array 1, a pixel signal readout circuit 2, a control circuit 3 and an image processing circuit 4.

In one embodiment, the global shutter high dynamic range pixel array 1 comprises plural global shutter high dynamic range pixels 11 arranged in an array of rows and columns as shown in FIG. 3. In this embodiment, each of the global shutter high dynamic range pixels 11 includes: a photoelectric transducer unit PT, a floating node FD, a first charge transfer unit PATH1, a second charge transfer unit PATH2 and a pixel signal output unit OU, as the above-mentioned global shutter high dynamic range pixel 11 shown in FIG. 1.

The pixel signal readout circuit 2 is coupled to the global shutter high dynamic range pixel array 1 and is configured to read out the first pixel signal Spix1 (in the case that charges are transferred from the photoelectric transducer unit PT to the floating node FD via the first charge transfer unit PATH1, wherein the first pixel signal Spix1 corresponds to a voltage potential V at the floating node FD during this first charge transfer period) and/or the second pixel signal Spix2 (in the case that charges are transferred from the photoelectric transducer unit PT to the floating node FD via the second charge transfer unit PATH2, wherein the second pixel signal Spix2 corresponds to a voltage potential V at the floating node FD during this second charge transfer period), of each global shutter high dynamic range pixel 11. In one embodiment, the pixel signal readout circuit 2 can include, for example but not limited to, a pixel signal processing circuit 21 and a signal line 22. The first pixel signals Spix1 and the second pixel signals Spix2 outputted from the global shutter high dynamic range pixels 11 in respective columns are transmitted to corresponding pixel signal processing circuits 21 via column signal lines CL, and an initial image signal Simg is outputted via the signal line 22.

The control circuit 3 is coupled to the global shutter high dynamic range pixel array 1. In one embodiment, the control circuit 3 can include, for example but not limited to, a row decoder circuit 31 and a row driver circuit 32. The control circuit 3 is configured to generate the following signals: the control signal G_SD, the control signal G_SS, the control signal G_TG1, the control signal G_TG2, the reset signal G_AB, the row selection signal G_RSL and/or the reset signal G_RST, to control the global shutter high dynamic range pixels 11. The control circuit 3 can output the above-mentioned signals to each global shutter high dynamic range pixel 11 via a corresponding driving line DL.

The image processing circuit 4 is coupled to the pixel signal readout circuit 2 and is configured to process the initial image signal Simg outputted from the pixel signal readout circuit 2, so as to output an image signal Sout having a high dynamic range.

Moreover, the global shutter high dynamic range image sensor 10 of this embodiment can further include a clock generation circuit 5 and a column decoder circuit 6. The clock generation circuit 5 is configured to operably generate a clock signal to control the pixel signal readout circuit 2. The column decoder circuit 6 is coupled to the pixel signal readout circuit 2 and is configured to operably decode the signals transmitted to the pixel signal processing circuits 21 via the column signal lines CL.

Because the above-mentioned row decoder circuit 31, row driver circuit 32, clock generation circuit 5 and column decoder circuit 6 are well known to those skilled in the art, the details thereof are not redundantly explained here.

Because the global shutter high dynamic range image sensor 10 of this embodiment comprises the global shutter high dynamic range pixels 11, so it has the advantages and efficacies that the global shutter high dynamic range pixel 11 has, which are not redundantly repeated here.

Please refer to FIG. 6, which shows waveforms of signals of the present invention. As shown in FIG. 6, the first charge transfer period is defined as a period from a turned-OFF time point of the reset transistor AB to a turned-OFF time point of the shutter switch SS, whereas, the second charge transfer period is defined as a period from a turned-OFF time point of the reset transistor AB to a turned-OFF time point of the transfer switch TG2.

As mentioned above, because the second charge transfer unit PATH2 only employs the transfer switch TG2 to control the transfer of the charges from the photoelectric transducer unit PT to the floating node FD and because there is no any other charge storage device in the second charge transfer unit PATH2, the second charge transfer period which is taken to transfer at least a portion of the charges from the photoelectric transducer unit PT to the floating node FD via the second charge transfer unit PATH2 is shorter than the first charge transfer period which is taken to transfer at least a portion of the charges from the photoelectric transducer unit PT to the floating node FD via the first charge transfer unit PATH1. As shown in FIG. 6, it is clear that the second charge transfer period (i.e., a short exposure) is shorter than the first charge transfer period (i.e., a long exposure).

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, a device which does not substantially influence the primary function of a signal can be inserted between any two devices in the shown embodiments, such as a switch or a resistor. For another example, it is not limited for a high level of the signal to represent ON and a low level of the signal to represent OFF. The meaning of a high level and the meaning of a low level of the signal are interchangeable, with corresponding amendments of the circuits processing these signals. For yet another example, the substrate of the present invention is not limited to a P-type semiconductor substrate. The substrate of the present invention can be an N-type semiconductor substrate or any other type of semiconductor substrate, with corresponding modifications of the conductivity type and concentrations of dopants in the doped regions. For still another example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A global shutter high dynamic range pixel, comprising:
a photoelectric transducer unit, which is configured to operably receive a light signal and generate and accumulate charges accordingly, so as to output a sensing signal corresponding to the charges;
a floating node, which is configured to operably accumulate at least a first portion and/or a second portion of the charges transferred from the photoelectric transducer unit as floating charges;
a first charge transfer unit, which is coupled between the photoelectric transducer unit and the floating node and which is configured to operably transfer at least the first portion of the charges from the photoelectric transducer unit to the floating node during a first charge transfer period;
a second charge transfer unit, which is coupled between the photoelectric transducer unit and the floating node and which is configured to operably transfer at least the second portion of the charges from the photoelectric transducer unit to the floating node during a second charge transfer period, wherein the second charge transfer period is shorter than the first charge transfer period; and
a pixel signal output unit, which has one end coupled to the floating node and which is configured to operably generate a first pixel signal corresponding to a first voltage potential in the floating node during the first charge transfer period and/or to operably generate a second pixel signal corresponding to a second voltage potential in the floating node during the second charge transfer period;
wherein the first charge transfer unit includes:
a metal-oxide-semiconductor (MOS) capacitor, which is configured to operably and temporarily accumulate the first portion of the charges transferred from the photoelectric transducer unit, the MOS capacitor being turned ON or OFF according to a first control signal, whereby a gate-induced potential well is formed internally within the MOS capacitor, so as to control the transfer of the first portion of the charges.

2. The global shutter high dynamic range pixel of claim 1, wherein the first charge transfer unit further includes:
a shutter switch, which is coupled between the photoelectric transducer unit and one end of the MOS capacitor and which is controlled by a second control signal, so as to control the transfer of the first portion of the charges from the photoelectric transducer unit to the MOS capacitor; and
a transfer switch, which is coupled between another end of the MOS capacitor and the floating node, the transfer switch being controlled by a third control signal, so as to control the transfer of the first portion of the charges from the MOS capacitor to the floating node as the floating charges.

3. The global shutter high dynamic range pixel of claim 1, wherein the second charge transfer unit includes:
a transfer switch, which is coupled between the photoelectric transducer unit and the floating node, the transfer switch being controlled by a second control signal, so as to control the transfer of the second portion of the charges from the photoelectric transducer unit to the floating node as the floating charges.

4. The global shutter high dynamic range pixel of claim 1, wherein the photoelectric transducer unit includes a photodiode, a photo-gate or a photo-conductor.

5. The global shutter high dynamic range pixel of claim 2, wherein the global shutter high dynamic range pixel further includes:
a first reset transistor, which is coupled to one end of the photoelectric transducer unit and which is configured to operably reset a level of the photoelectric transducer unit to a first predetermined level; and
a second reset transistor, which is coupled to one end of the floating node and which is configured to operably reset a level of the floating node to a second predetermined level.

6. The global shutter high dynamic range pixel of claim 3, wherein the global shutter high dynamic range pixel further includes:
a first reset transistor, which is coupled to one end of the photoelectric transducer unit and which is configured to operably reset a level of the photoelectric transducer unit to a first predetermined level; and
a second reset transistor, which is coupled to one end of the floating node and which is configured to operably reset a level of the floating node to a second predetermined level.

7. The global shutter high dynamic range pixel of claim 5, wherein:
the first charge transfer period is from a turned-OFF time point of the first reset transistor to a turned-OFF time point of the shutter switch; and
the second charge transfer period is from a turned-OFF time point of the first reset transistor to a turned-OFF time point of the transfer switch.

8. The global shutter high dynamic range pixel of claim 6, wherein:
the first charge transfer period is from a turned-OFF time point of the first reset transistor to a turned-OFF time point of the shutter switch; and
the second charge transfer period is from a turned-OFF time point of the first reset transistor to a turned-OFF time point of the transfer switch.

9. A global shutter high dynamic range image sensor, comprising:
a global shutter high dynamic range pixel array, including:
a plurality of global shutter high dynamic range pixels arranged in an array of rows and columns, each of the global shutter high dynamic range pixel includes:
a photoelectric transducer unit, which is configured to operably receive a light signal and generate and accumulate charges accordingly, so as to output a sensing signal corresponding to the charges;
a floating node, which is configured to operably accumulate at least a first portion and/or a second portion of the charges transferred from the photoelectric transducer unit as floating charges;
a first charge transfer unit, which is coupled between the photoelectric transducer unit and the floating node and which is configured to operably transfer at least a first portion of the charges from the photoelectric transducer unit to the floating node during a first charge transfer period;
a second charge transfer unit, which is coupled between the photoelectric transducer unit and the floating node and which is configured to operably transfer at least a second portion of the charges from the photoelectric transducer unit to the floating node during a second charge transfer period, wherein the second charge transfer period is shorter than the first charge transfer period; and
a pixel signal output unit, which has one end coupled to the floating node and which is configured to operably generate a first pixel signal corresponding to a first voltage potential in the floating node during the first charge transfer period and/or a second pixel signal corresponding to a second voltage potential in the floating node during the second charge transfer period;
wherein the first charge transfer unit includes:
a metal-oxide-semiconductor (MOS) capacitor, which is configured to operably and temporarily accumulate at least the first portion of the charges transferred from the photoelectric transducer unit, the MOS capacitor being turned ON or OFF according to a first control signal, whereby a gate-induced potential well is formed internally within the MOS capacitor, so as to control the transfer of the first portion of the charges;
a control circuit, which is coupled to the global shutter high dynamic range pixel array and which is configured to operably generate the first control signal, so as to control the plurality of global shutter high dynamic range pixels;
a pixel signal readout circuit, which is coupled to the global shutter high dynamic range pixel array and which is configured to operably read out the first pixel signal and the second pixel signal of each global shutter high dynamic range pixel; and
an image processing circuit, which is coupled to the pixel signal readout circuit and which is configured to operably process a signal outputted from the pixel signal readout circuit.

10. A global shutter high dynamic range image sensor of claim 9, wherein the first charge transfer unit further includes:
a shutter switch, which is coupled between the photoelectric transducer unit and one end of the MOS capacitor and which is controlled by a second control signal, so as to control the transfer of the first portion of the charges from the photoelectric transducer unit to the MOS capacitor; and
a transfer switch, which is coupled between another end of the MOS capacitor and the floating node, the transfer switch being controlled by a third control signal, so as to control the transfer of the first portion of the charges from the MOS capacitor to the floating node as the floating charges.

11. A global shutter high dynamic range image sensor of claim 9, wherein the second charge transfer unit includes:
a transfer switch, which is coupled between the photoelectric transducer unit and the floating node, the transfer switch being controlled by a second control signal, so as to control the transfer of at least the second portion of the charges from the photoelectric transducer unit to the floating node as the floating charges.

12. A global shutter high dynamic range image sensor of claim 9, wherein the photoelectric transducer unit includes a photodiode, a photo-gate or a photo-conductor.

13. A global shutter high dynamic range image sensor of claim 10, wherein the global shutter high dynamic range pixel further includes:
a first reset transistor, which is coupled to one end of the photoelectric transducer unit and which is configured to operably reset a level of the photoelectric transducer unit to a first predetermined level; and
a second reset transistor, which is coupled to one end of the floating node and which is configured to operably reset a level of the floating node to a second predetermined level.

14. A global shutter high dynamic range image sensor of claim 11, wherein the global shutter high dynamic range pixel further includes:
a first reset transistor, which is coupled to one end of the photoelectric transducer unit and which is configured to operably reset a level of the photoelectric transducer unit to a first predetermined level; and
a second reset transistor, which is coupled to one end of the floating node and which is configured to operably reset a level of the floating node to a second predetermined level.

15. A global shutter high dynamic range image sensor of claim 13, wherein:
the first charge transfer period is from a turned-OFF time point of the first reset transistor to a turned-OFF time point of the shutter switch; and
the second charge transfer period is from a turned-OFF time point of the first reset transistor to a turned-OFF time point of the transfer switch.

16. A global shutter high dynamic range image sensor of claim 14, wherein:
the first charge transfer period is from a turned-OFF time point of the first reset transistor to a turned-OFF time point of the shutter switch; and
the second charge transfer period is from a turned-OFF time point of the first reset transistor to a turned-OFF time point of the transfer switch.
